(19) United States
(12) Patent Application Publication
(10) Pub. No.: US 2019/0343109 A1
(43) Pub. Date: Nov. 14, 2019

(54) Tree stand

(71) Applicant: Doran Ray Bittner, Paris, MI (US)

(72) Inventor: Doran Ray Bittner, Paris, MI (US)

(21) Appl. No.: 16/602,015

(22) Filed: Jul. 19, 2019

Related U.S. Application Data
(63) Continuation-in-part of application No. 15/932,738, filed on Apr. 17, 2018.
(60) Provisional application No. 62/602,230, filed on Apr. 17, 2017.

(51) Int. Cl. A01M 31/02

(52) U.S. Cl. CPC A01M 31/02

(57) ABSTRACT

A collapsible, portable tree stand assembly for use by hunters, outdoorsmen or a similar user for positioning the user at a suitable elevation above the ground upon the trunk of a tree or similar vertical support. The tree stand assembly includes an extension ladder having an upper and a lower ladder section, a folding frame member adapted to forcibly contact said tree at one end thereof and to be pivotally attached to the upper end of the upper ladder section, a generally planar seat member pivotally attached to the folding frame member, a generally planar foot platform pivotally attached to the upper ladder section below the upper end of the upper ladder section and a folding support strut attached at one end thereof to the foot platform and at the other end thereof to the upper end of the upper ladder section.

### BACKGROUND OF THE INVENTION

This application is a continuation-in-part of U.S. patent application Ser. No. 15/932,738 filed Apr. 17, 2018 filed from U.S. Provisional Patent Application Ser. No. 62/602,230 filed Apr. 17, 2017. The instant invention relates to tree stands used by hunters. As a rule, the installation of a tree stand requires at least two people and is often frustrated by overhanging branches. In addition, as a rule, the platform of most ladder tree stands gets in the way of attaching the upper end of the stand to a tree and can even cause the hunter to lose his balance and risk falling from the tree. It would be an advance in this art if a tree stand were discovered that could be installed by one person in a safer manner.

### SUMMARY OF THE INVENTION

The instant invention is the discovery of a tree stand that can be installed by one person and in a safer manner than ladder tree stands of the prior art. More specifically, the instant invention is collapsible, portable tree stand assembly for use by hunters, outdoorsmen or a similar user for positioning the user at a suitable elevation above the ground upon the trunk of a tree or similar vertical support, said tree stand assembly comprising:
(a) an extension ladder comprising an upper and a lower ladder section;
(b) a folding frame member adapted to forcibly contact said tree at one end thereof and to be pivotally attached to the upper end of the upper ladder section;
(c) a generally planar seat member pivotally attached to the folding frame member;
(d) a generally planar foot platform pivotally attached to the upper ladder section below the upper end of the upper ladder section; and
(e) a folding support strut attached at one end thereof to the foot platform and at the other end thereof to the upper end of the upper ladder section.

In another embodiment, the instant invention is a method for erecting a tree stand comprising the steps of:
(a) vertically elevating the extension ladder sections of the tree stand assembly of claim 1 near the base of a tree with the folding frame member and the seat member in their folded position so that the folding frame member forcibly contacts said tree;
(b) climbing the extension ladder and folding the seat up so that the folding frame member can be secured to the tree; and
(c) unfolding the folding frame member, the seat and the foot platform, to provide a seat and foot platform for the user.

In yet another embodiment the instant invention is a portable tree stand assembly for use by hunters, outdoorsmen or a similar user for positioning the user at a suitable elevation above the ground upon the trunk of a tree or similar vertical support, said tree stand assembly comprising:
(a) a ladder section;
(b) a folding frame member adapted to forcibly contact said tree at one end thereof and to be pivotally attached to the upper end of the ladder section;
(c) a generally planar seat member pivotally attached to the folding frame member;
(d) a generally planar foot platform pivotally attached to the ladder section below the upper end of the ladder section; and
(e) a folding support strut attached at one end thereof to the foot platform and at the other end thereof to the upper end of the ladder section.

### BRIEF DESCRIPTION OF THE DRAWINGS

FIG. 1 is a perspective view of the upper end of a highly preferred embodiment of the instant invention strapped to a tree and with the seat and foot platform unfolded;

FIG. 2 is a side view of the upper end of an unextended highly preferred embodiment of the instant invention with the seat and foot platform folded;

FIG. 3 is a side view of an unextended highly preferred embodiment of the instant invention resting on a tree with the seat and foot platform folded;

FIG. 4 is a side view of an extended highly preferred embodiment of the instant invention resting on a tree with the seat and foot platform folded; and

FIG. 5 is a side view of an extended highly preferred embodiment of the instant invention strapped to a tree with the seat and foot platforms unfolded.

### DETAILED DESCRIPTION OF THE INVENTION

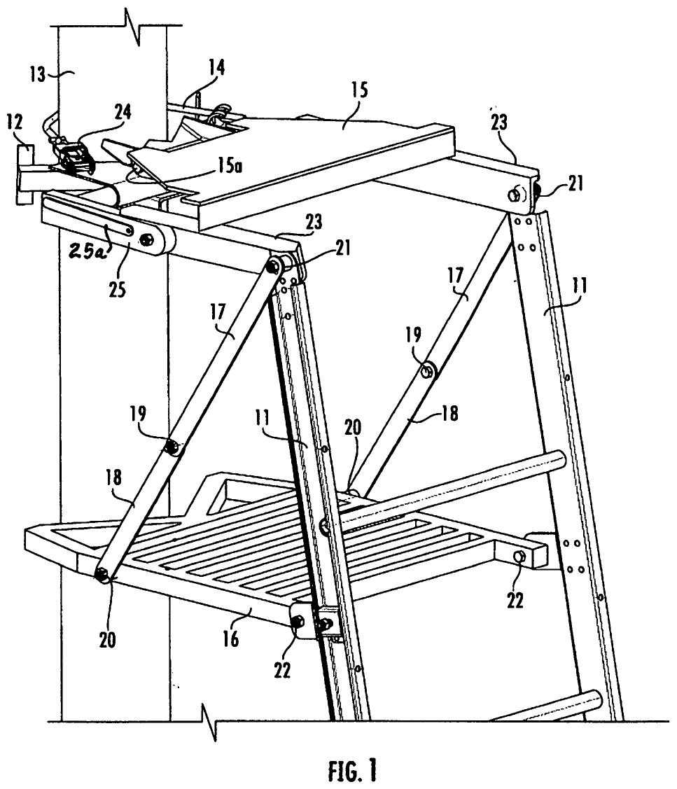

Referring now to FIG. 1, therein is shown a perspective view of the upper end of an extended highly preferred embodiment 10 of the instant invention strapped to tree 13 by strap 14. A folding frame member comprised of tree grasping fork 12 and folding links 23 and 25 is pivotally attached to the upper end of rails 11 of the upper section of an extension ladder by bolts 21. Seat 15 is pivotally attached to the folding frame member by hinge 15a. Foot platform 16 is pivotally attached to the rails 11 of the upper section of the extension ladder by bolts 22. A folding support strut comprised of links 17 and 18 is attached at one end thereof to foot platform 16 by bolts 20 and at the other end thereof to the upper end of rails 11 by bolts 21. Buckle 24 is provided at the end of strap 14.

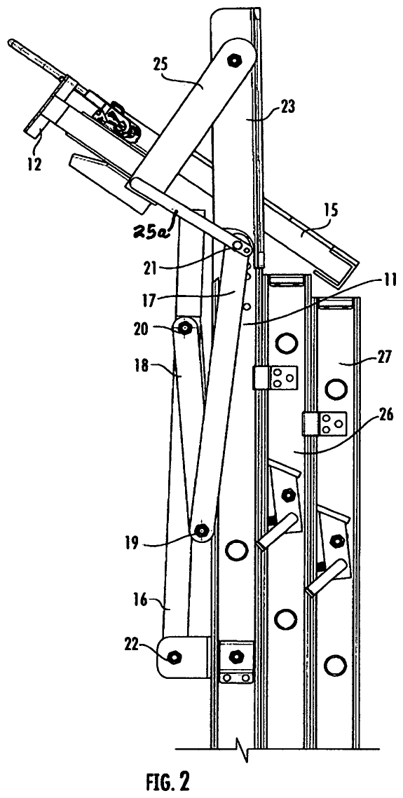

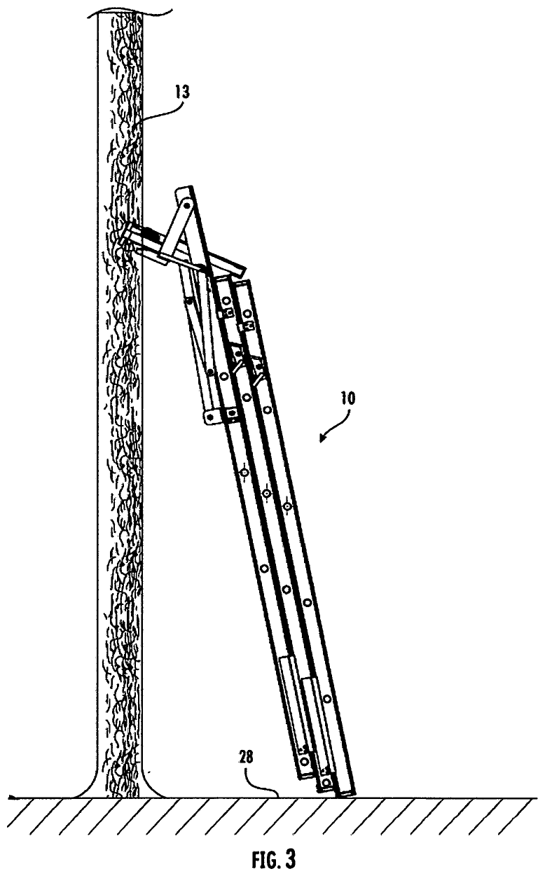

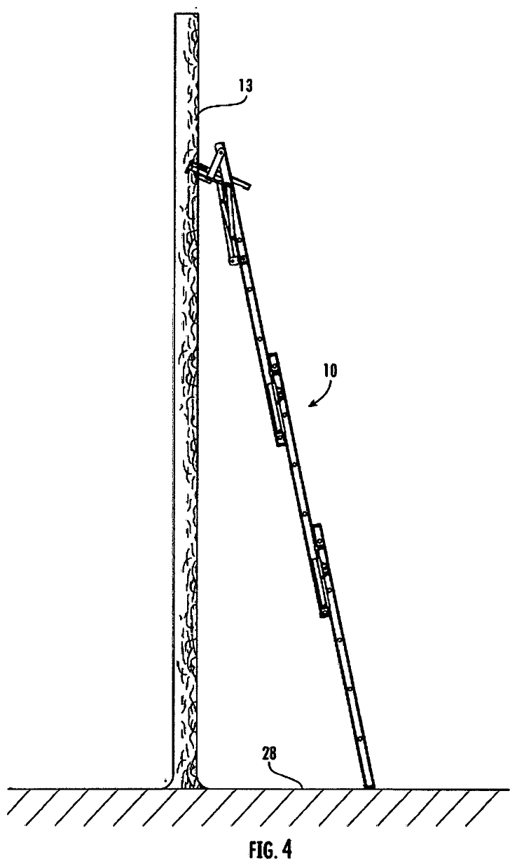

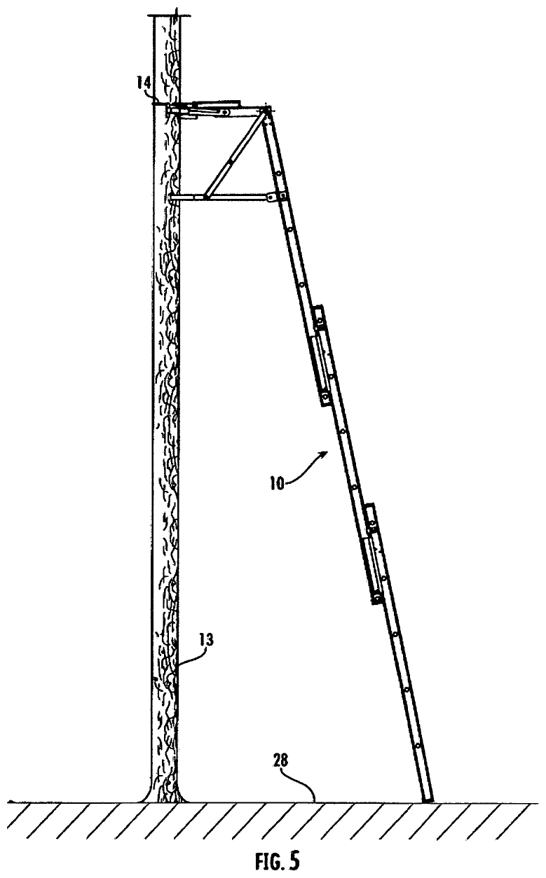

Referring now to FIG. 2, therein is shown a side view of embodiment 10 shown in FIG. 1 with the folding frame member and foot platform in their folded positions assisted by rubber retaining strap 25a attached to bolt 21. The extension ladder shown in FIG. 2 is a triple extension ladder comprised of rails 11, 26 and 27. Referring now to FIG. 3, therein is shown embodiment 10 of FIG. 2 on ground 28 leaning against tree 13. Referring now to FIG. 4, therein is shown embodiment 10 of FIG. 3 on ground 28 leaning against tree 13 with the extension ladder in its extended position. A user of embodiment 10 can climb the extension ladder, pivot the seat up so that strap 14 can be attached to tree 13 and then unfold the folding frame member and foot platform as shown in FIG. 5.

The components of the instant invention can be made of any suitable material but preferably are primarily made of extruded aluminum. The tree stand of the instant invention can be erected by one person. Since the tree stand of the instant invention can comprise an extension ladder the tree stand of the instant invention can be erected even when overhanging branches would obstruct the installation of the conventional ladder tree stand. The fact that the upper end of the tree stand of the instant invention can be secured to a tree before the seat and foot platform are unfolded provides a significant safety advantage over tree stands having fixed seats and foot platforms. The tree stand of the instant invention can utilize a single ladder section or an extension ladder having two or more ladder sections. The embodiment shown in FIG. 1 shows the instant invention with a single ladder section.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A collapsible, portable tree stand assembly for use by hunters, outdoorsmen or a similar user for positioning the user at a suitable elevation above the ground upon the trunk of a tree or similar vertical support, said tree stand assembly comprising:
(a) an extension ladder comprising an upper and a lower ladder section;
(b) a folding frame member adapted to forcibly contact said tree at one end thereof and to be pivotally attached to the upper end of the upper ladder section;
(c) a generally planar seat member pivotally attached to the folding frame member;
(d) a generally planar foot platform pivotally attached to the upper ladder section below the upper end of the upper ladder section; and
(e) a folding support strut attached at one end thereof to the foot platform and at the other end thereof to the upper end of the upper ladder section.

2. A method for erecting a tree stand comprising the steps of:
(a) vertically elevating the extension ladder sections of the tree stand assembly of claim 1 near the base of a tree with the folding frame member and the seat member in their folded position so that the folding frame member forcibly contacts said tree;
(b) climbing the extension ladder and folding the seat up so that the folding frame member can be secured to the tree; and
(c) unfolding the folding frame member, the seat and the foot platform, to provide a seat and foot platform for the user.

3. A portable tree stand assembly for use by hunters, outdoorsmen or a similar user for positioning the user at a suitable elevation above the ground upon the trunk of a tree or similar vertical support, said tree stand assembly comprising:
(a) a ladder section;
(b) a folding frame member adapted to forcibly contact said tree at one end thereof and to be pivotally attached to the upper end of the ladder section;
(c) a generally planar seat member pivotally attached to the folding frame member;
(d) a generally planar foot platform pivotally attached to the ladder section below the upper end of the ladder section; and
(e) a folding support strut attached at one end thereof to the foot platform and at the other end thereof to the upper end of the ladder section.
